(19) United States
(12) Patent Application Publication
(10) Pub. No.: US 2005/0127147 A1
(43) Pub. Date: Jun. 16, 2005

(54) [METHOD OF FORMING BOND MICROSTRUCTURE]

(76) Inventors: CHENG-HENG KAO, TAOYUAN (TW); JUI-YUN TSAI, TAOYUAN (TW); CHIEN-WEI CHANG, TAOYUAN (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,488

(22) Filed: Mar. 7, 2004

(30) Foreign Application Priority Data
Dec. 16, 2003 (TW) 92135508

(51) Int. Cl. B23K 31/02

(52) U.S. Cl. 228/254

(57) ABSTRACT

A method for controlling the bond microstructures is disclosed. A Sn layer and an Au layer are sequentially formed on the two members that are to be jointed. The weight ratio of Sn/Au is 20:80 having a variation range about ±3-4%. Next, the Sn layer and the Au layer are treated with a first temperature or a second temperature so that the Sn layer and the Au layer react to form a bond microstructure connecting two members. When the Sn layer and the Au layer are treated with the first temperature, the bond microstructure will have a layered structure. When the Sn layer and the Au layer are treated with the second temperature, the bond microstructure will have an eutectic structure. Therefore, the bond microstructures can be manufactured with a diferent of characteristics by treating with a different of temperatures for suiting various industrial applications.

### CROSS REFERENCE TO RELATED APPLICATIONS

This application claims the priority benefit of Taiwan application serial no.92135508, filed on Dec. 16, 2003.

### BACKGROUND OF INVENTION

1. Field of the Invention

The present invention relates to a method of forming a bond microstructure, and more particularly to a method of forming bond microstructures having different characteristics.

2. Description of Related Art

Electronic devices are widely used in different applications. Chips are essential components of electronic devices. Chips have to be packaged for both protection and communication with the other external circuits. For example, chips and substrates can be packaged and connected by a flip-chip package process, and then substrate is connected with printed circuit boards by a soldering process. The chips, substrates and printed circuit boards are connected through several bond microstructures. The microstructures can be formed, for example, by reflowing metal layers in a reflow process. The microstructures serve the interconnection between the electronic devices and also provide mechanical support thereto. It is believed that about 80% failure of electronic devices is directly or indirectly related to the bond microstructures. Therefore, reliability of the bond is very important.

It should be noted that Au—Sn alloy having better thermal conductivity and mechanical strength than those of Au—Si alloy, and therefore widely used in electronic device package to serve as the bond microstructures. Moreover, the Au—Sn alloy having a weight ratio 80:20, i.e., Au20Sn, is most popular in the industry. It can be applied to connect two substrates or to fix fibers on a substrate.

However, different packages of electronic devices require different bond microstructures characteristics. Therefore, bond microstructures having different characteristics thereof, such as thermal conductivity or mechanical properties, are highly desirable.

### SUMMARY OF INVENTION

The present invention is directed to a method of a bond microstructure having different characteristics for suiting various industrial applications. The tin layer and the gold layer are treated with different heating temperature to form bond microstructures having different characteristics. The treatment conditions can be adjusted to manufacture bond microstructures having desired characteristics according to requirements of electronic devices.

The present invention provides a method of forming a bond microstructure. A tin layer and a gold layer are sequentially formed on one of the two members. The weight ratio of tin to gold is 20:80 with a variation range of about ±3-4%. Next, the tin layer and the gold layer are treated with a first temperature or a second temperature for forming bond microstructures having different characteristics. The bond microstructure is used for connecting the two members. According to one embodiment, when the tin and gold layers are treated with the first temperature, the bond microstructure will have a layered structure; and when the tin and gold layers are treated with the second temperature, the bond microstructure will have a eutectic structure.

The present invention also discloses another method of forming a bond microstructure. A tin layer and a gold layer are respectively formed on two members. For example, the weight ratio of tin to gold is 20:80 with a variation range of about ±3-4%. The tin layer and the gold layer are treated with a first temperature or a second temperature to form bond microstructures having different characteristics. The bond microstructure is used for connecting the two members. According to one embodiment of the present invention, when the tin and gold layers are treated with the first temperature, the bond microstructure will have a layered structure; and when the tin and gold layers are treated with the second temperature, the bond microstructure will have an eutectic structure.

In one embodiment of the present invention, the first temperature is no more than 280° C., and preferably within a range of 240-280° C. The bond layered structure comprises an AuSn layer structure and an Au₅Sn layer structure. In one preferred embodiment of the present invention, the second temperature is higher than 280° C., and the bond eutectic structure comprises AuSn and Au₅Sn.

In one embodiment of the present invention, the gold layer is formed on one of the two members, and then the tin layer is formed over the gold layer. In another embodiments, the tin layer is formed on one of the two members, and then the gold layer is formed over the tin layer. For example, the tin layer is formed by performing an electroplating process, an evaporation process, an electroless plating process or a sputtering process. The step of heating the tin layer and the gold layer is accomplished by heating under pressure or a thermal reflow method.

In one embodiment of the present invention, an adhesion layer, a barrier layer and a wetting layer are sequentially formed on one or both of the two members before forming the tin layer and the gold layer. The adhesion layer comprises titanium or chromium. The barrier layer comprises Co, Ni, Pt or Pd. The wetting layer comprises Au or Cu.

In one embodiment of the present invention, the members comprise a flip chip and a substrate, or a photo-electronic device and a substrate.

The present invention uses different heating temperature for treating the tin layer and gold layer to form a bond microstructure having desired characteristics, such as conductivity, thermal conductivity or mechanical strength, according to requirements of electronic devices.

In order to make the aforementioned and other objects, features and advantages of the present invention understandable, a preferred embodiment accompanied with figures is described in detail below.

### BRIEF DESCRIPTION OF DRAWINGS

FIG. 1A is a process flow showing a preferred method for controlling a microstructure of the present invention.

FIG. 1B is a process flowchart showing a method of forming a microstructure according to one embodiment of the present invention.

FIG. 2A is a SEM picture of a bond microstructure formed via treatment at 280° C.

FIG. 2B is a SEM picture of a bond microstructure formed via treatment at 290° C.

FIG. 3A is a SEM picture of another bond microstructure formed via treatment at 280° C.

FIG. 3B is a SEM picture of another bond microstructure formed via treatment at 290° C.

### DETAILED DESCRIPTION

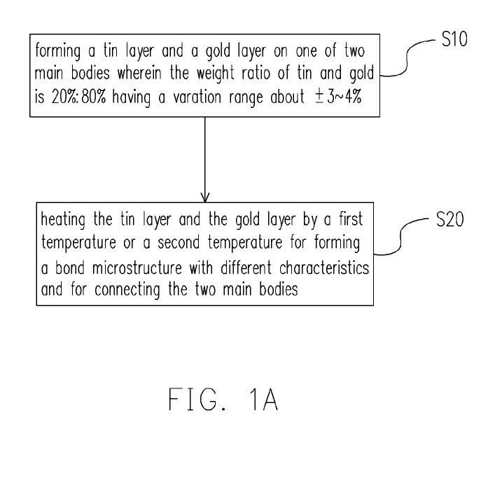

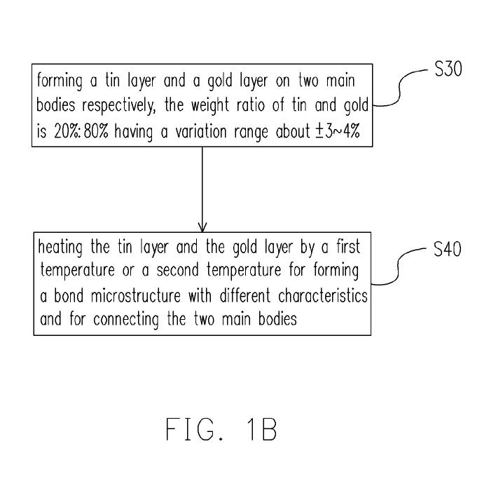

FIG. 1A is a process flowchart showing a method of forming a microstructure according to one preferred embodiment of the present invention. Referring to FIG. 1A, a tin layer and a gold layer are sequentially formed on one of two members in step S10. The % weight ratio of tin to gold is about 20:80 having a variation range of about ±3-4%, for example. The two members are, for example, a flip chip and a substrate, or a photo-electronic device and a substrate. In one embodiment, the tin layer is formed on one of the member and then the gold layer is formed over the tin layer, and vice versa. The tin layer and the gold layer can be formed by performing known conventional process, such as, an electroplating process, an evaporation evaporation, an electroless plating or sputtering process.

Next, the tin layer and the gold layer are treated with a first temperature or a second temperature to form a bond microstructure in step S20. The bond microstructure is used to connect the two members. It is to be understood that the bond microstructure formed under the first temperature treatment will have characteristics different the bond microstructure formed under the second temperature treatment, and accordingly, a suitable temperature may be selected for treating the tin and gold layers to obtain bond microstructure having characteristics for suiting various industrial applications. In one embodiment of the present invention, the first temperature is no more than 280° C., and preferably within a range of about 240-280° C. When the tin layer and the gold layer are treated under the first temperature, the bond microstructure will have a layered structure comprising an AuSn layer and an Au₅Sn layer. In one embodiment of the present invention, the second temperature is higher than 280° C. When the tin layer and the gold layer are treated under the second temperature, the bond microstructure will have an eutectic structure comprising AuSn and Au₅Sn. In addition, the first and second temperature can be achieved by performing by heating under pressure or a thermal reflow method.

One of ordinary skill in the art can perceive that an adhesion layer, a barrier layer and a wetting layer may be sequentially formed on one or both of the two members before forming the tin layer and the gold layer for enhancing adhesion and barrier properties between the bond microstructure and the members. The adhesion layer comprises titanium or chromium. The barrier layer comprises Co, Ni, Pt or Pd. The wetting layer comprises Au or Cu.

As described in the above embodiment of the present invention, the tin layer and the gold layer are formed on one of the two members with reference to FIG. 1A. However, the present invention is not limited thereto. The tin layer can be formed on one of the two members and the gold layer can be formed on the other member to achieve the purpose of the present invention. As shown in FIG. 1B, a tin layer and a gold layer are respectively formed over two members in step S30. The % weight ratio of tin to gold is about 20:80 having a variation range of about ±3˜4%. Next, the tin layer and the gold layer are treated under a first temperature or a second temperature to form a bond microstructure in step S40. The bond microstructure is used to connect the two members in step S40.

It should be noted that when the tin layer and the gold layer are treated under the first temperature, for example, at no more than 280° C., the bond microstructure will have a layered structure comprising an AuSn layer and an Au₅Sn layer. When the tin layer and the gold layer are treated under the second temperature, for example, at a temperature higher than 280° C., the bond microstructure will have an eutectic structure comprising AuSn and Au₅Sn. In other words, according to the present invention, the bond microstructure formed under the first temperature treatment will have characteristics different the bond microstructure formed under the second temperature treatment. Accordingly, a suitable temperature may be selected for treating the tin and gold layers to obtain bond microstructure with desired characteristics according to various requirements.

In order to describe how the temperature treatments affect the characteristics of the bond microstructure, two preferred embodiments are described below.

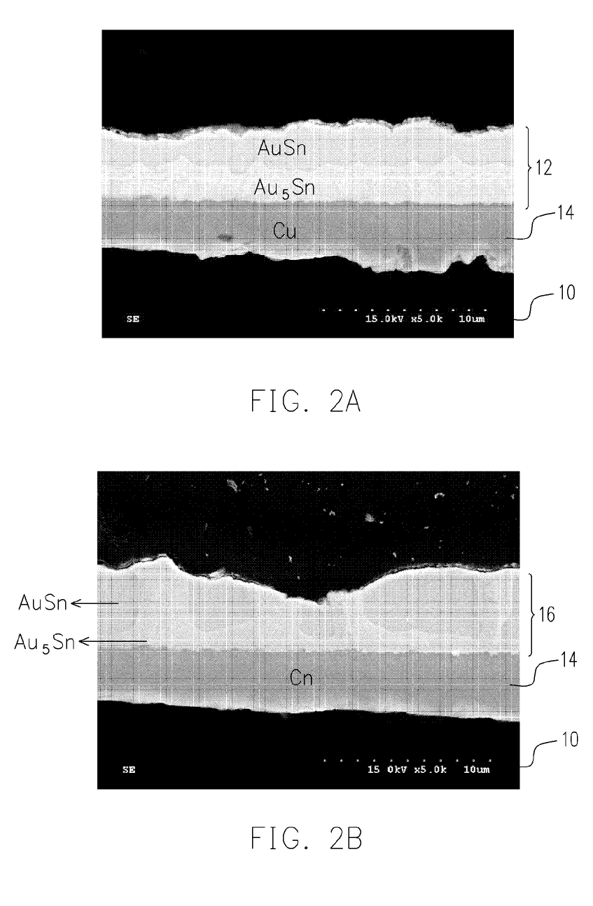

FIG. 2A is a SEM picture of a bond microstructure formed via treatment at 280° C. FIG. 2B is a SEM picture of a bond microstructure formed via treatment at 290° C.

Referring to FIG. 2A, a copper layer, a tin layer and a gold layer are sequentially formed on a silicon substrate 10 via evaporation process. The copper layer, the tin layer and the gold layer have thickness of about 4 μm, 3.2 μm and 2.13 μm, respectively. The % weight ratio of gold to tin is about 20:80 having a variation range of about +3˜4%, wherein the ratio of gold to tin can be achieved by, for example, controlling the thickness of the gold layer and the tin layer. Referring to FIG. 2A, when the tin layer and the gold layer are treated at 280° C., the bond microstructure 12 will have a layered structure comprising an AuSn layer and an Au₅Sn layer. The copper layer 14 between the silicon substrate 10 and the bond microstructure 12 serves as the wetting layer for enhancing adhesion between the silicon substrate 10 and the bond microstructure 12.

Referring to FIG. 2B, when the tin layer and the gold layer are treated at 290° C., the bond microstructure 16 will have an eutectic structure comprising AuSn and Au₅Sn. Similarly, the copper layer 14 between the silicon substrate 10 and the bond microstructure 16 serves as the wetting layer for enhancing adhesion between the silicon substrate 10 and the bond microstructure 16.

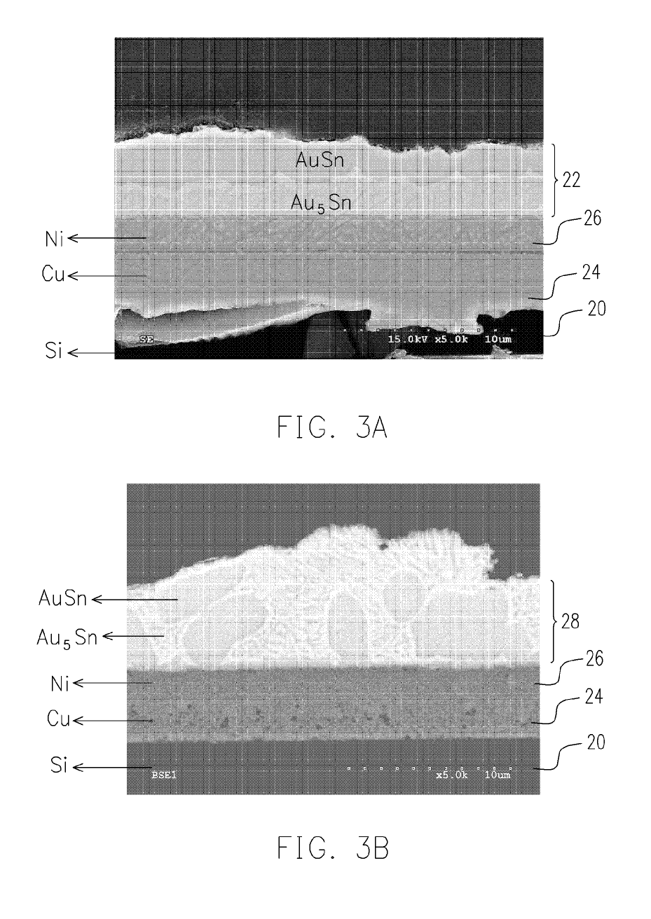

FIG. 3A is a SEM picture of another bond microstructure formed via treatment at 280° C. FIG. 3B is a SEM picture of another bond microstructure formed via treatment at 290° C.

Referring to FIG. 3A, a copper layer, a nickel layer, a tin layer and a gold layer are sequentially formed on a silicon substrate 20 via evaporation process. For example, the copper layer, the nickle layer and the tin layer have thickness 4 μm, 2 μm, 3.2 μm and 2.13 μm respectively. The % weight ratio of gold to tin is about 20:80 having a variation range about 3˜4%, wherein the ratio of gold to tin can be achieved by, for example, controlling the thickness of the gold layer and the tin layer. As shown in FIG. 3A, when the tin layer and the gold layer are treated at 280° C., the bond microstructure 22 will have a layered structure comprising an AuSn layer and an Au₅Sn layer. The copper layer 24 between the silicon substrate 20 and the layer structure 22 serves as the wetting layer for enhancing adhesion between the silicon substrate 10 and the bond microstructure 22. The nickel layer 26 between the copper layer 24 and the bond microstructure 22 serves as the barrier layer for preventing the downward diffusion of tin from the bond microstructure structure 22.

Referring to FIG. 3B, when the tin layer and the gold layer are treated at 290° C., the bond microstructure 28 will have an eutectic structure comprising AuSn and Au₅Sn. Similarly, the copper layer 24 between the silicon substrate 20 and the bond microstructure 28 serves as the wetting layer for enhancing adhesion between the silicon substrate 20 and the eutectic structure 28. The nickel layer 26 between the copper layer 24 and the eutectic structure 28 serves as the barrier layer for preventing the downward diffusion of tin from the bond microstructure 22.

Accordingly, bond microstructures having different characteristics can be obtained by treating the gold and tin layers, and the like, with different temperatures to suit various requirements. Moreover, the % weight ratio of tin and gold may also be altered for obtaining a bond microstructure with different characteristics, such as conductivity, heat or mechanical strength, for suiting various requirements of electronic devices.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A method of forming a bond microstructure, comprising:
sequentially forming a tin layer and a gold layer on one of two members, a % weight ratio of tin to gold being 20:80 having a variation range of about ±3˜4%; and treating the tin layer and the gold layer with a first temperature or a second temperature to form bond microstructures having different characteristics, wherein when the tin layer and the gold layer are treated with the first temperature, the bond microstructure will have a layered structure and when the tin layer and the gold layer are treated with the second temperature, the bond microstructure will have an eutectic structure.

2. The method of claim 1, wherein the first temperature is no more than 280° C.

3. The method of claim 1, wherein the bond microstructure having the layered structure comprises an AuSn layer and an Au₅Sn layer.

4. The method of claim 1, wherein the second temperature is higher than 280° C.

5. The method of claim 1, wherein the bond microstructure having the eutectic structure comprises AuSn and Au₅Sn.

6. The method for controlling a bond microstructure of claim 1, wherein the step of treating the tin layer and the gold layer with the first temperature or the second temperature comprises heating under pressure or a reflowing method.

7. The method of claim 1, wherein the the gold layer is formed over the tin layer.

8. The method of claim 1, wherein the tin layer is formed over the gold layer.

9. The method of claim 1, wherein the tin layer is formed by performing an electroplating process, an evaporation process, an electroless plating or a sputtering process.

10. The method of claim 1, further comprising forming an adhesion layer, a barrier layer and a wetting layer on one or both of the two members before forming the tin layer and the gold layer on one of the two members.

11. The method of claim 10, wherein the adhesion layer comprises titanium or chromium.

12. The method of claim 10, wherein the barrier layer comprises Co, Ni, Pt or Pd.

13. The method of claim 10, wherein the wetting layer comprises Au or Cu.

14. The method of claim 1, wherein the two members comprise a flip chip and a substrate.

15. The method of claim 1, wherein the two members comprise a photo-electronic device and a substrate.

16. A method of forming a bond microstructure, comprising:
sequentially forming a tin layer and a gold layer on two members respectively, the % weight ratio of tin to gold being 20:80 having a variation range about ±3˜4%; and treating the tin layer and the gold layer with a first temperature or a second temperature to form bond microstructures having different characteristics, wherein when the tin layer and the gold layer are treated with the first temperature, the bond microstructure will have a layered structure and when the tin layer and the gold layer are treated with the second temperature, the bond microstructure will have an eutectic structure.

17. The method of claim 16, wherein the first temperature is no more than 280° C.

18. The method of claim 16, wherein the bond microstructure having the layered structure comprises an AuSn layer and an Au₅Sn layer.

19. The method for controlling a bond microstructure of claim 16, wherein the second temperature is higher than 280° C.

20. The method for controlling a bond microstructure of claim 16, wherein the bond microstructure having the eutectic structure comprises AuSn and Au₅Sn.

21. The method of claim 16, wherein the step of treating the tin layer and the gold layer with the first temperature of the second temperature comprises heating under pressure or a reflowing method.

22. The method of claim 16, wherein the tin layer is formed by performing an electroplating process, an evaporation process, an electroless plating process or a sputtering process.

23. The method of claim 16, further comprising forming an adhesion layer, a barrier layer and a wetting layer on one or both of the two members before forming the tin layer and the gold layer on the two members.

24. The method of claim 23, wherein the adhesion layer comprises titanium or chromium.

25. The method of claim 23, wherein the barrier layer comprises Co, Ni, Pt or Pd.

26. The method of claim 23, wherein the wetting layer comprises Au or Cu.

27. The method of claim 16, wherein the two members comprise a flip chip and a substrate.

28. The method of claim 16, wherein the two members comprise a photo-electronic device and a substrate.
